(19) United States
(12) Patent Application Publication
(10) Pub. No.: US 2009/0161011 A1
(43) Pub. Date: Jun. 25, 2009

(54) FRAME RATE CONVERSION METHOD BASED ON GLOBAL MOTION ESTIMATION

(76) Inventors: BARAK HURWITZ, Alonim (IL); Alex Zaretsky, Nesher (IL); Omri Govrin, Misgav (IL); Avi Levy, Tivon (IL)

Correspondence Address: CARRIE A. BOONE, P.C., 2450 Louisiana, Suite # 400-711, HOUSTON, TX, 77006, US

(21) Appl. No.: 11/962,540

(22) Filed: Dec. 21, 2007

(51) Int. Cl. H04N 5/44

(52) U.S. Cl. 348/459; 348/E05.11

(57) ABSTRACT

Embodiments of a frame rate conversion (FRC) method use two or more frames to detect and determine their relative motion. An interpolated frame between the two frames may be created using a derived motion, a time stamp given, and consecutive frame data. Global estimation of each frame is utilized, resulting in reduced occlusion, reduced interpolation artifacts, selective elimination of judder, graceful degradation, and low complexity.

### TECHNICAL FIELD

This application relates to frame rate conversion of a video sequence and, more particularly, to methods for frame rate up-conversion.

### BACKGROUND

Frame Rate Conversion (denoted FRC) is an operation that changes (usually increases) the frame rate of a given video sequence. FRC reconstructs the missing frames when needed by duplicating or interpolating existing frames. Motion compensated FRC uses motion analysis of the video sequence for achieving high quality interpolation.

Common input frame rates are: 15, 24, 25, 29.97, 30, 50, 59.94, and 60 frames per second (fps). Common output frame rates are: 50, 59.94, 60 72, 75, and 85 fps. From the input and the output rates, a time stamp for the missing output frames can be calculated. This time stamp defines the relative position of the expected output frame between two adjacent input frames. FIG. 1 illustrates a frame rate up-conversion from 30 to 60 fps. Time stamps 1.5, 2.5, and 3.5 are calculated for the 60 fps frame, based on the positions of the 30 fps frames.

Based on previous and consecutive input frames and according to the time stamp, the FRC operation determines how to create the missing frames when doing up-conversion. Down conversion is done by dropping certain frames and is not further discussed herein.

There are three main alternative methods for generating the missing frames during frame rate up-conversion: drop/repeat (also known as duplication or replication), interpolation, and motion compensation. FIG. 2 illustrates differences between the drop/repeat method for frame rate up-conversion and the motion compensation method. In the drop/repeat method, the simplest of the three, the previous frame is used as the missing one. The drop/repeat method is illustrated at the top of FIG. 2. For the two inserted frames at times T_{1/3} and T_{2/3} (calculated as in FIG. 1), the frame at position T₀ is simply duplicated. The drop/repeat method may cause judder artifacts (described in more detail below) when there is a significant motion in the scene. The interpolation method uses weighted interpolation from consecutive frames to produce the corresponding pixels of the missing frame. The interpolation method may cause image blur and object doubling.

Motion compensation (MC) is a more complex method for frame rate up-conversion than the other two, and is based on an estimation of pixel location in consecutive frames. Most MC-based methods uses re-sampling (by interpolation), based on per pixel and/or per block, motion estimation (ME). Motion compensation FRC is illustrated at the bottom of FIG. 2. Based on the position of the red circle in the frame at times T₀ and T₁, the positions of the red circle at times T_{1/3} and T_{2/3} is estimated.

Motion compensation may cause certain artifacts, such as “blockiness” near edges of moving objects (see FIG. 9), caused by using block-based decisions, and flickering caused by temporal inconsistencies in the decision making process. Other artifacts (blur, judder, object doubling) can also been seen when the motion estimation is erroneous.

When a video scene includes significant moving objects, the human visual system is tracking the motion of the objects. When the FRC operation uses frame duplication (drop/repeat), the location of the objects in consecutive frames does not change smoothly, which interferes with the visual system tracking mechanism. This collision causes a sense of “jumpy”, non-continuous motion called “judder”. A significant motion causes a larger gap between the expected position and the actual position, producing a larger judder artifact (most noticeable on camera pan movements).

It should be noted however, that in many cases of complex motion, such as a multiplicity of objects moving to various directions at various speeds, or a complicated camera motion, the judder effect is not noticeable under the drop/repeat method. This is probably due to the inability of the eye to track several different motions simultaneously, sensing no single, defined “expected” position of the objects in the missing frame.

Thus, there is a continuing need for a frame rate up-conversion method that avoids producing artifacts.

### BRIEF DESCRIPTION OF THE DRAWINGS

The foregoing aspects and many of the attendant advantages of this document will become more readily appreciated as the same becomes better understood by reference to the following detailed description, when taken in conjunction with the accompanying drawings, wherein like reference numerals refer to like parts throughout the various views, unless otherwise specified.

FIG. 1 is a block diagram illustrating a frame rate up-conversion from 30 fps to 60 fps, according to some embodiments;

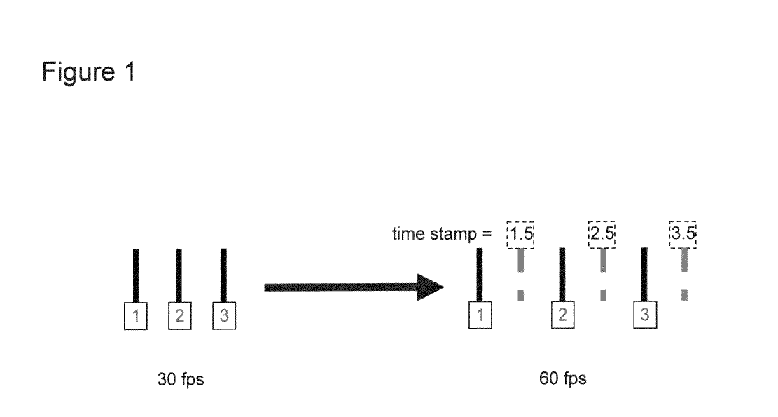

FIG. 2 is a block diagram illustrating motion compensation versus drop/repeat for performing frame rate up-conversion, according to some embodiments;

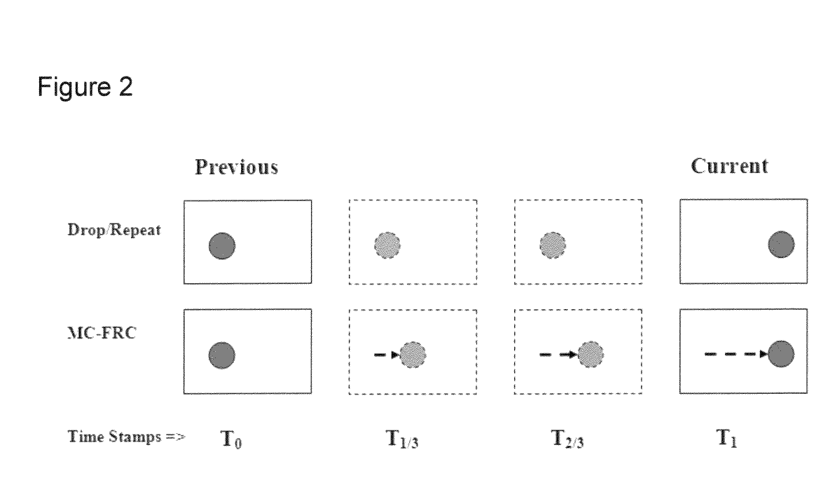

FIG. 3 is a block diagram illustrating a frame rate conversion method, according to some embodiments;

FIG. 4 is a detailed block diagram of the frame rate conversion method of FIG. 3, according to some embodiments;

FIG. 5 is a flow diagram showing operation the frame rate conversion method of FIG. 3, according to some embodiments;

FIG. 6 is a two-dimensional histogram of motion vectors, according to some embodiments;

FIG. 7 is a three-dimensional histogram of the motion vectors of FIG. 6, according to some embodiments;

FIG. 8 is a diagram illustrating occlusion, according to some embodiments;

FIG. 9 is an image that has been frame rate converted using motion compensation and block decision, according to some embodiments;

FIG. 10 is an image that has been frame rate converted using the frame rate conversion method of FIG. 3, according to some embodiments; and

FIG. 11 is a block diagram showing the frame rate conversion method of FIG. 3 implemented in processor-based system, according to some embodiments.

### DETAILED DESCRIPTION

In accordance with the embodiments described herein, a frame rate conversion (FRC) method is disclosed. Embodiments of the invention may use two or more frames to detect and determine their relative motion. The interpolated frame between the two frames may be created using the derived motion, the time stamp given, and the consecutive frame's data. Global estimation of each frame may result in reduced occlusion, reduced interpolation artifacts, selective elimination of judder, graceful degradation, and low complexity.

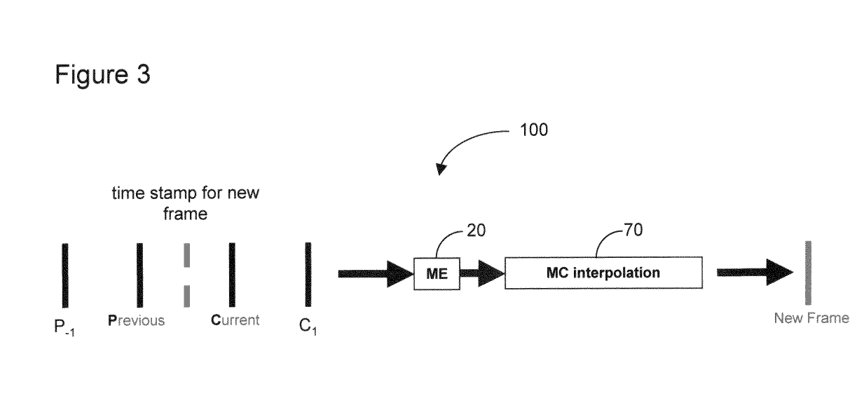

FIG. 3 is an upper-level diagram showing the flow of a frame rate conversion (FRC) method 100, according to some embodiments. The FRC method 100 takes as input a current frame (C) and a previous frame (P). The FRC method 100 first generates a time stamp between the two frames, P and C. The FRC method 100 then performs motion estimation (ME) 20, which calculates motion vectors (MV) 60, and motion compensation (MC) interpolation 70 to generate a new frame. The motion estimation 20 and motion compensation interpolation 70 operations are described in more detail below.

The FRC method 100 is described herein with regard to two adjacent frames (P and C). Nevertheless, designers of ordinary skill in the art will recognize that the principles of the FRC method 100 may be applied to more than two frames taken from preceding and following segments. The FRC method 100 thus optionally receives additional frames adjacent to the P frames, designated P₋ₙ, . . . , P₋₂, P₋₁, and optionally receives additional frames adjacent to the C frames, designated, C₁, C₂, . . . , Cₙ.

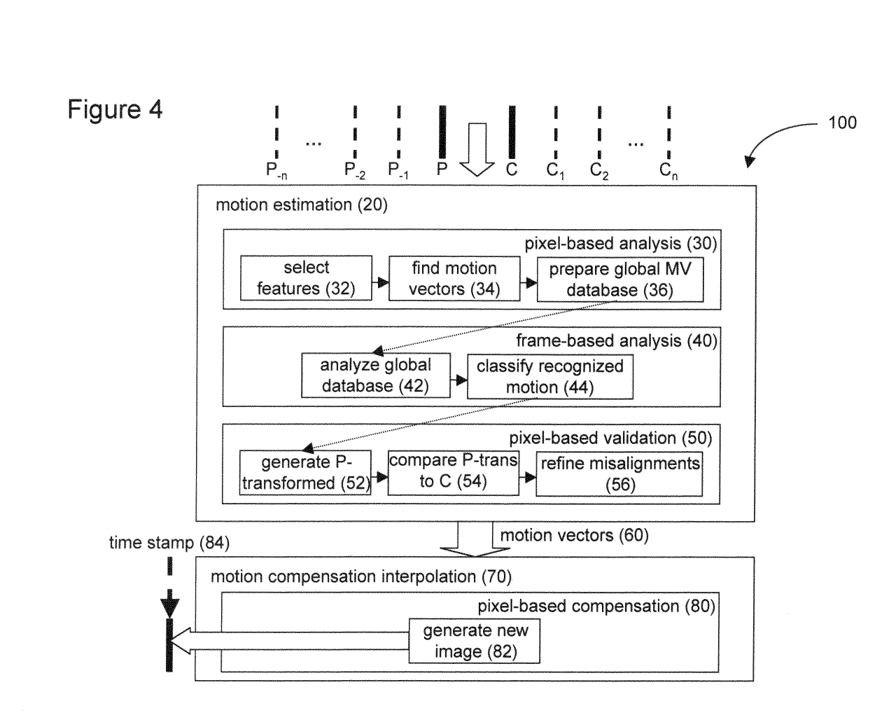

FIG. 4 is a more detailed block diagram of the FRC method 100, according to some embodiments. The FRC method 100 may be thought of as a system, including functional blocks as indicated in FIG. 4. The FRC method 100 operates on the previous (P) frame, the current (C) frame, and optionally other adjacent previous frames (P₋ₙ, . . . , P₋₂, P₋₁) and current frames (C₁, C₂, . . . , Cₙ). As in FIG. 3, the FRC method 100 consists of motion estimation 20 and motion compensation interpolation 70. The motion estimation phase 20 is further divided into pixel-based analysis 30, frame-based analysis 40, and pixel-based validation 50.

The first stage of the motion estimation phase 20 is pixel-based analysis 30. This stage 30 is used for gathering information for the frame-based analysis 40. One or more features are selected 32, motion vectors 60 for each of the selected features are obtained 34, and the motion vectors 60 are stored in a global motion vector database 36.

To select the features 32, in a selected reference frame, the FRC method 100 searches for pixels (denoted as features) that will produce a good motion evaluation. In some embodiments, the reference frame is the current frame, C. In some embodiments, the motion vectors 60 are obtained selectively, not comprehensively (for each pixel), so as to save computation time and produce better results. By procuring motion vectors only for significant features within the frame, the FRC method 100 avoids automatically performing searches of all pixels in the frame, thus saving time and computation resources.

For example, if the pixel neighborhood presents high spatial variation (detailed area) and high temporal variation (moving), the FRC method 100 adds the feature, e.g., the pixel position of the feature in the image(x,y), to the feature list. Spatial and temporal variations may be defined as follows:

$$Temporal Variation = {\sum }_{5 \times 5} \vert {I}_{Cur} - {I}_{Prev} \vert$$

$$Spatial Variation = {\sum }_{5 \times 5} \frac{1}{2} \cdot ( \vert \frac{d {I}_{Cur}}{d x} \vert + \vert \frac{d {I}_{Cur}}{d y} \vert )$$

$${I}_{Cur} - Intensity Current , {I}_{Pre} - Intensity Previous$$

To find the motion vectors 60, for each pixel chosen as a feature, the FRC method 100 finds the best matching position in the selected target frame. In some embodiments, the target frame is the P frame. This can be done by using a correlation-based full search or similar methods, or by using optical flow. The result of the pixel-based analysis 30 is to generate a motion vector 60 for each pixel.

The pixel-based analysis 30 results in the preparation of a global motion vector database 36. The FRC method 100 summarizes the motion vector results obtained and arranges them in a defined database for further (frame-based) analysis 40. The data gathering process is not “blind” and some spatial validation can be done for consistency of the motion vector results.

The FRC method 100 next proceeds to the frame-based analysis 40. In this stage, the information gathered from the previous stage is analyzed, and a decision is made, based on the transformation needed to best align the target image with the reference image. Again, the reference image is referred to as C (current) and the target image as P (previous), however additional input frames may be part of the analysis, as described above. In the frame-based analysis 40, the global motion vector database generated in the pixel-based analysis 30 is analyzed 42, with the result being the best transformation needed to align between the P and C frames. This transformation can be found using a registration-based or a histogram-based analysis, or using other methods employing motion vectors statistics.

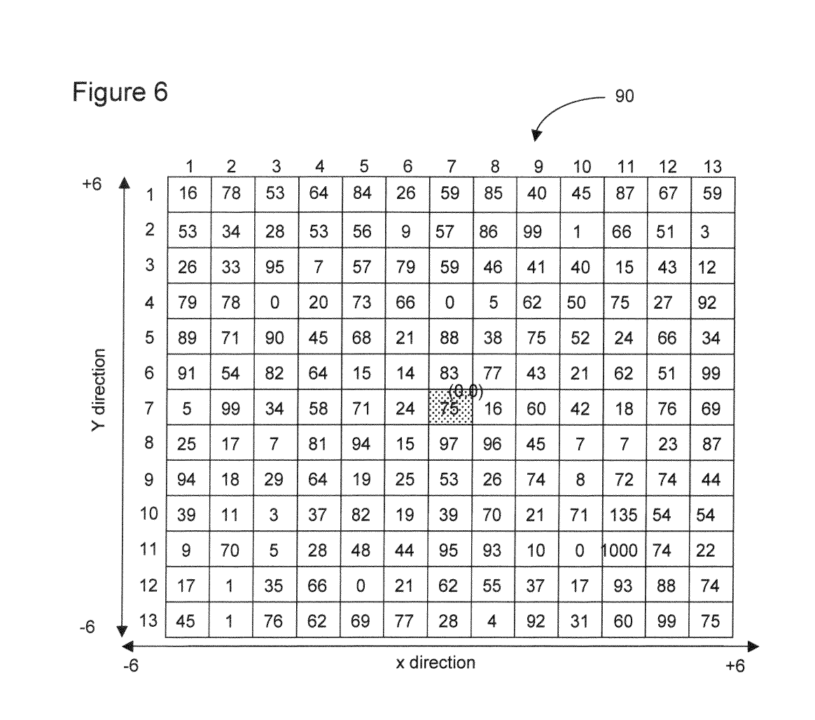

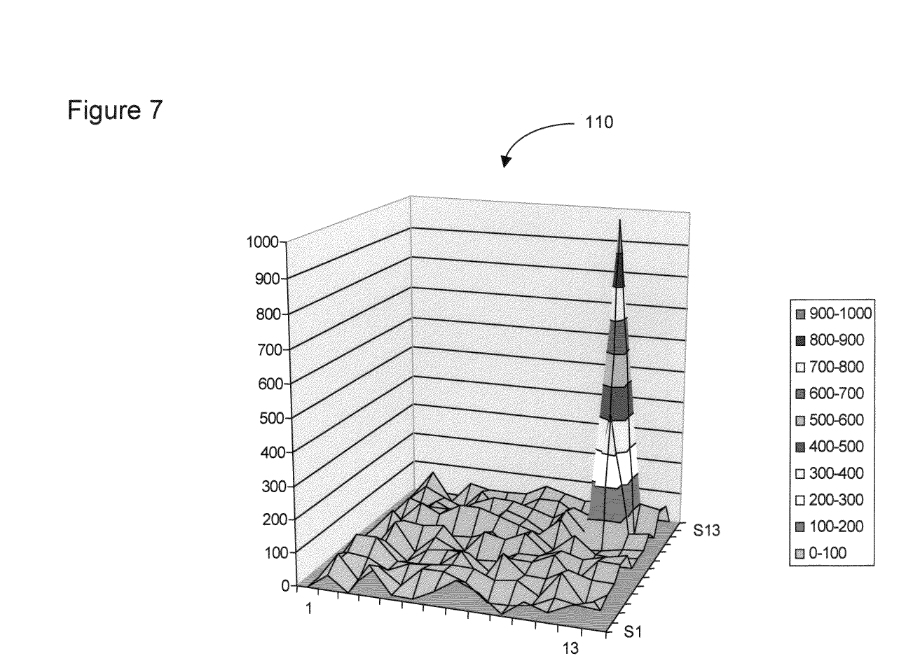

For example, if there is only a global translation between the two frames, a peak in the motion histogram will be formed, as demonstrated in the histogram of motion vectors 90 of FIG. 6, according to some embodiments. Each bin in the histogram represents the number of features found translated to the direction designated by the X and Y coordinates. The ranges for each axis are defined by the search area. Each bin in the histogram represents the number of features found in that direction. The graph 110 of FIG. 7 shows that in global translation, most of the features lie in one bin. For more complicated global motion, transformations other then pure translation can be used, such as the affine transform, utilizing known registration methods.

Next, the frame-based analysis 40 classifies the recognized motions 44. Based on the analysis of the global database, classification into several possible categories is performed. In some embodiments, the FRC method 100 classifies the motions into four possible categories: global motion (any general transformation), no motion, complex motion, or few objects moving. Each classification results in a different method being employed for the missing frame construction. For example, if the histogram peak in FIG. 7 passes some threshold criteria, such as size and width, and the other bins are only poorly populated (under another threshold), the FRC method 100 would classify the frame as a global motion frame. In some embodiments, the classification is done per frame.

Where the motion is classified as either a complex motion or no motion, the FRC method 100 employs the drop/repeat (duplication) method, in some embodiments. This is a valid approach for either complex motions or no motion, since no judder artifact is expected in those cases. Further, the drop/repeat method is faster and safer, in some embodiments, than other methods for generating missing frames.

Returning to FIG. 4, the motion estimation phase 20 of the FRC method 100 also performs pixel-based validation 50. In this stage, the FRC method 100 applies the previously derived transformation on the P image 52 and compares between the P-transformed and the C images 54. The pixel-based validation 50 looks for significant differences zones and searches alternative alignments for these zones.

In generating the P-transformed frame 52, the FRC method 100 performs the transformation found in a previous stage (in the motion estimation stage 20). In other words, the FRC method 100 aligns the P frame with the C frame. To compare the P-transformed frame with the current frame C 54, the FRC method 100 checks for misalignments, using the following SAD operand (sum absolute differences):

$$S A D = {\sum }_{5 \times 5} \vert {I}_{Cur} - {I}_{Prev} \vert$$

Alternatively, the comparison step 50 may employ other difference estimation methods or correlation methods between the P-transformed frame and the C frame.

Also in the pixel-based validation 50, the FRC method 100 refines misalignments 56. In some embodiments, the FRC method 100 analyzes each significant area of misalignment and finds the best new alignment for it, using a search method. For each new alignment, consider the tradeoff between adapting it or keeping the global alignment. In many cases, keeping the global motion will not cause judder or artifact, so this choice will be preferred over the more complicated and less error tolerant option of moving a group of isolated pixels differently.

In addition to the motion estimation 20, the FRC method 100 also performs motion compensation 70. In this final stage, the generation of the missing frames 82 is done (per each time stamp) based on the decisions from the motion estimation block 20.

In some embodiments, there exist two options for generating the new frame in the FRC method 100. First, motion compensation may be performed, using the motion estimation, as illustrated in FIGS. 3 and 4. In this case, the missing frame pixels will be taken from adjacent frames according to the calculated motion vectors, using an appropriate interpolation method. Second, the frames may simply be duplicated (drop/repeat) from the nearest frame (depending on the time stamp). In some embodiments, the FRC method 100 uses the duplication method in two cases: where there is no judder artifact and where the artifact caused by motion compensation may be stronger than the perceived judder.

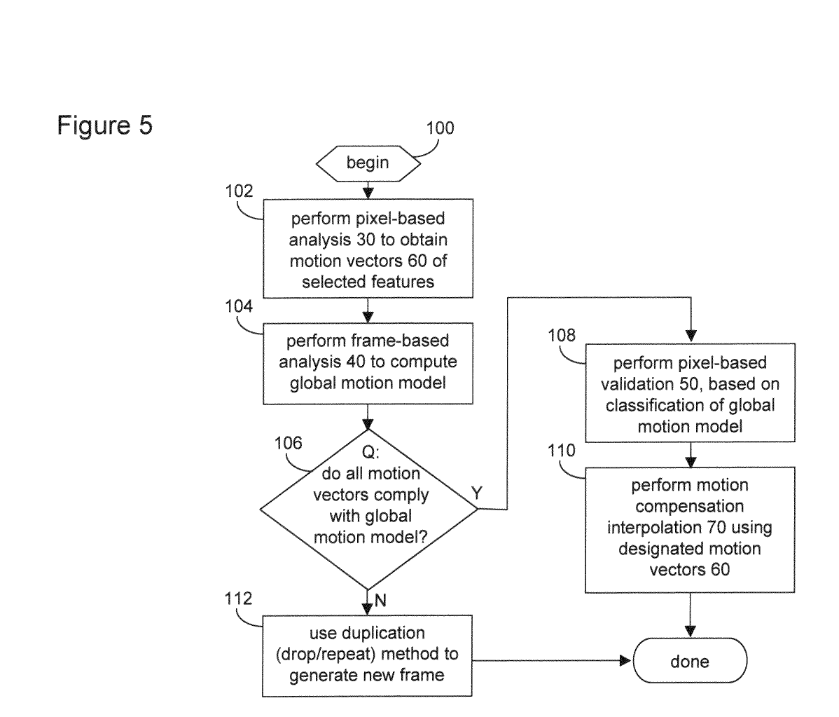

The decision whether to duplicate the frame is made during frame-based analysis 40, where the recognized motion is classified. FIG. 5 is a flow diagram illustrating operation of the FRC method 100, according to some embodiments. In the motion estimation stage 20, the FRC method 100 performs pixel-based analysis 30 (block 102). It is in the pixel-based analysis 30 that motion vectors 60 are generated for selected features. The FRC method 100 next performs frame-based analysis 40, to compute a global motion model (block 104). A global motion model results when all motions (one or more) in the frame can be classified. In such a case, the frame is declared valid. If the motions cannot be classified, or if there is no motion, the frame is declared not valid. In the frame-based analysis 40, the selected features are classified as being either global motion model (any general transformation), no motion model, complex motion model, or few objects moving model.

If the motions are classified as not complying with the global motion model (block 106), then the known drop/repeat method for generating the new frame is used (block 112). Otherwise, the third phase of the motion estimation 20 is performed, pixel-based validation (block 108), based on the classification of the global motion model. Motion compensation interpolation 70, including pixel-based compensation 80 using the motion vectors 60, is then performed (block 110). As FIG. 5 illustrates, the FRC method 100 uses a known method for frame rate up-conversion, duplication, where it is strategically sound to do so.

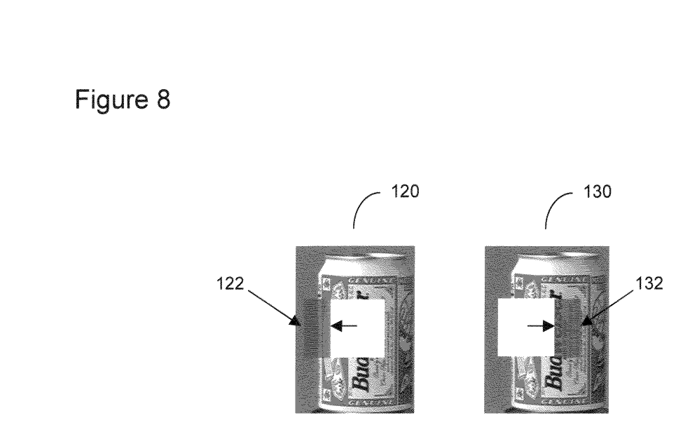

Occlusion occurs due to object movement in the scene, during which details behind the objects are obscured in one side and revealed in the other side. In FIG. 8, for example, blue zones in one image are obscured in the other image. For these two zones, there are no motion vectors in the scene. The rectangular portion 122 left of the arrow in the image 120 and the rectangular portion 132 right of the arrow in the image 130 show the problematic parts of the images where the motion vector will be wrong (using prior art methods), since there is no valid motion vector in those areas.

In some embodiments, the FRC method 100 addresses occlusion, as illustrated in the following example. Referring to FIG. 8, assume a known motion of an object (white square) and a different know motion of the background (beer can). Analyzing both forward and backward directions for matching, It can be concluded that the occluded zone on the left side of the object should be taken from the left image, and the occlude zone on the right side should be taken from the right image.

In general, most prior art frame rate conversion algorithms eventually search for a motion vector for each pixel. This approach is not robust enough for many typical video sequences. Pixel-based motion estimation may be erroneous when the video sequence is noisy, has complex details, or contains many objects moving in different directions. For such cases, the prior art algorithms tend to generate strong visual artifacts expressed in different forms, such as edge echoing around moving objects, false objects, flickering, and more. Appearance of such artifacts on the image makes the effects of frame rate conversion undesirable to the average viewer. In the FRC method 100, there is no need to estimate a motion vector for each pixel. Instead, using global image analysis, global motion is detected for the whole scene and/or for major objects within the scene. Motion vectors 60 are generated only for significant selected objects in the frame. Thus, the probability of artifacts occurring using the FRC method 100 is significantly mitigated, in some embodiments.

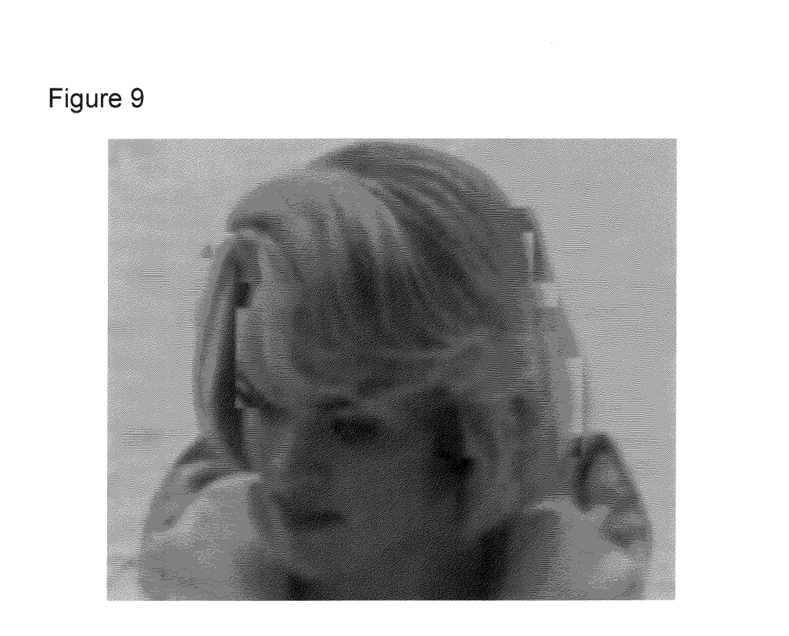

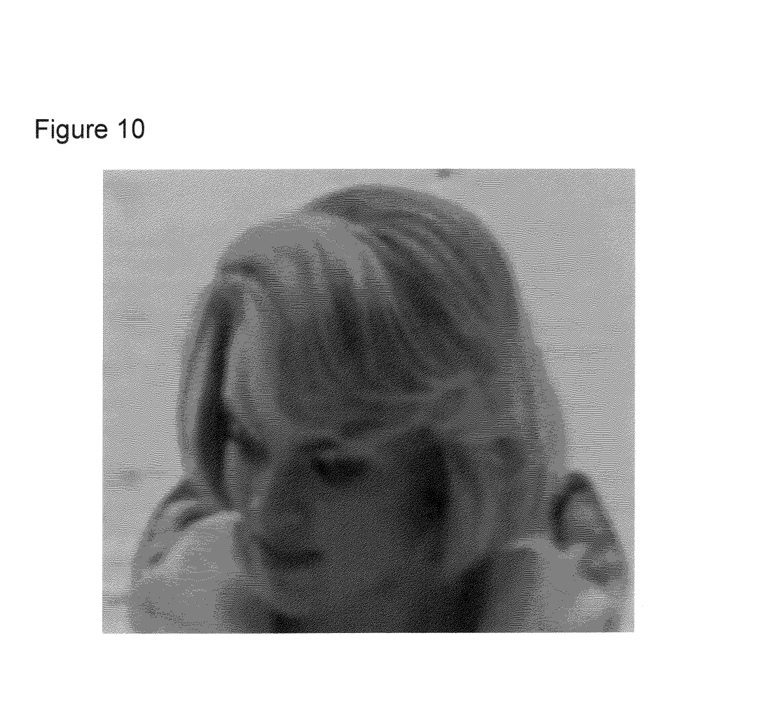

FIGS. 9 and 10 show the same image being frame rate up-converted, with significantly different results. In FIG. 9, motion compensation using the prior art block-based motion compensation (motion vector per block) method, described above, is used for frame rate up-conversion. In FIG. 10, the FRC method 100 using global estimation is used for frame rate up-conversion. Thus, the FRC method 100 generates reduced interpolation artifacts, relative to prior art methods.

The blockiness artifact seen in FIG. 9 is introduced due to per block variations in motion decisions. This artifact is perceived as flicker over time, producing a very annoying effect. In the FRC method 100, a global decision on the whole picture is taken and the newly created frame will be very similar to either the P frame or the C frame, presenting no spatial or temporal artifacts.

In some embodiments, the FRC method 100 eliminates judder only when necessary. Apart from reducing interpolation artifacts, the FRC method 100 exploits the fact that the judder artifact, the main disturbance which motion compensation FRC is designed to eliminate, exists mainly in cases of global motions. The most noticeable judder artifacts occur due to camera panning. It so happens that in complex motion patterns with no apparent global motion characteristics, the drop/repeat solution, trivial in comparison to other FRC methods, can be applied without causing judder. Thus, where it determines that the current frame is a global motion frame, the FRC method 100 uses the drop/repeat method for frame rate conversion.

The FRC method 100 is significantly less demanding (processing and memory-wise) than existing per-pixel motion estimation methods. The reason is that the pixel-based search operation, the most consuming stage, is performed only for a small portion of the pixels (the feature selection block).

The FRC method 100 solves the occlusion problem, in some embodiments. The occlusion problem is considered highly complex for other prior art methods, such as optical flow-based algorithms and block-based algorithms.

In some embodiments, the FRC method 100 performs graceful degradation whenever relevant. The FRC method 100 first analyzes the image and, following the classification process, a decision is made as to whether the sequence requires the motion compensation FRC or not, as illustrated in FIG. 5. The motion compensation phase is activated only when the “global motion” condition is met. Compensation is done based on global motion vectors rather than vectors per pixel or block. This prevents new artifacts caused by “noisy” motion vectors, as is likely to occur in the pixel-based approaches. If the “global motion” condition is not met, the FRC method 100 switches to graceful degradation namely, simple frame replication, and thus no spatial artifacts and no large temporal artifacts can be seen.

The FRC method 100 may be used in graphics processing units, whether they are software-based, hardware-based, or software- and hardware-based. The FRC method 100 can be implemented in complexity-constrained platforms, enabling an almost artifact-free frame rate increase. The FRC method 100 avoids artifacts that are either caused by the trivial duplication solution (judder artifacts) or by pixel-based motion compensated algorithms (pixel-specific artifacts).

The use of global motion estimation is not common for FRC applications. Most if not all FRC algorithms consider and employ many kinds of motion, particularly per-pixel motion vectors, thus may create a significant amount of artifacts. The use of motion histograms for global motion estimation is also new, and so is the idea that motion compensation should be done only for removing judder artifacts (caused mainly in global motion cases) and not on all cases.

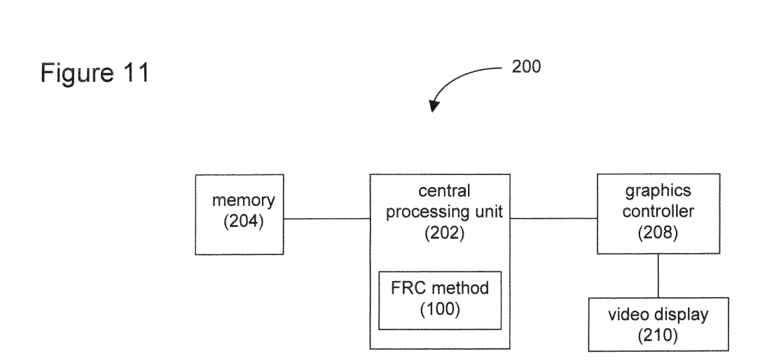

The FRC method 100 may be implemented as part of a graphics controller system, in which the FRC method is implemented in hardware, software, or a combination of hardware and software. Further, the FRC method 100 may be implemented as stand-alone software. FIG. 11 is a simplified block diagram of a processor-based system 200, including a central processing unit (CPU) 202, a memory 204, and a graphics controller 206 to drive a video display 208. In FIG. 11, the FRC method 100 is implemented in the CPU 202. The FRC method 100 may also be implemented in a combined CPU and graphics processing unit (GPU), a discrete graphics processor, or the FRC method 100 may be part of the internal hardware of a digital video device (DVD) system, a television (TV) chip, and so on.

While the application has been described with respect to a limited number of embodiments, those skilled in the art will appreciate numerous modifications and variations therefrom. It is intended that the appended claims cover all such modifications and variations as fall within the true spirit and scope of the invention.

We claim:

1. A frame rate conversion method, comprising:
performing pixel-based analysis of a reference frame and a previous frame to select features within the reference frame and generate a motion vector for the selected features;
performing frame-based analysis of results of the motion vector, wherein a motion model is classified as being a first type or a second type;
duplicating the reference frame where the model is the first type; and
performing motion compensation interpolation of an adjacent frame using the motion vector where the model is the second type.

2. The frame rate conversion method of claim 1, further comprising:
using a previous frame and the reference frame to validate the motion vector if the global motion model is the second type.

3. The frame rate conversion method of claim 1, performing pixel-based analysis of a reference frame further comprising:
selecting features from the reference frame;
generating the motion vector for the selected feature; and
preparing a global motion vector database to store the motion vector.

4. The frame rate conversion method of claim 3, performing frame-based analysis of the results of the motion vector further comprising:
analyzing the motion vector database; and
classifying the motion model as being either a global motion model, a no motion model, a complex motion model, or a few objects moving model; wherein the first type is either a no motion model or a complex motion model and the second type is either a global motion model or a few objects moving model.

5. The frame rate conversion method of claim 3, selecting features within the reference frame further comprising:
identifying high spatial variation locations; and
within the nigh spatial variable locations, identifying high temporal variation between the reference frame and the previous frame.

6. The frame rate conversion method of claim 1, performing pixel-based analysis of a reference frame and a previous frame further comprising:
performing spatial pixel-based analysis of a current frame; and
performing temporal pixel-based analysis between the reference frame and the previous frame.

7. The frame rate conversion method of claim 6, identifying high spatial variation further comprising:
using a spatial variation formula to generate spatial variation information.

8. The frame rate conversion method of claim 7, wherein the spatial variation formula is:
$$Spatial Variation = {\sum }_{5 \times 5} \frac{1}{2} \cdot ( \vert \frac{d {I}_{Cur}}{d x} \vert + \vert \frac{d {I}_{Cur}}{d y} \vert )$$
where I_{cur} is an intensity of the current frame and Iₚᵣₑ is an intensity of the previous frame.

9. The frame rate conversion method of claim 6, identifying high temporal variation further comprising:
using a temporal variation formula to generate temporal variation information.

10. The frame rate conversion method of claim 9, wherein the temporal variation formula is:
$$Temporal Variation = {\sum }_{5 \times 5} \vert {I}_{Cur} - {I}_{Prev} \vert$$
where I_{cur} is an intensity of the current frame and Iₚᵣₑ is an intensity of the previous frame.

11. The frame rate conversion method of claim 10, further comprising:
combining the temporal variation information and spatial variation information to select features for generation of the motion vector.

12. The frame rate conversion method of claim 3, generating the motion vector for the selected feature further comprising:
performing a search for a best match of selected features between the reference frame and the previous frame using a correlation method; and
generating the motion vector from the features in the reference frame to a found match in the previous frame.

13. The frame rate conversion method of claim 3, preparing a global motion vector database further comprising:
arranging all features and their associated motion vectors in a structure, such as a histogram suitable for further analysis.

14. The frame rate conversion method of claim 4, classifying the motion model further comprising:
calculating the motion vector per pixel derived from analysis of the motion vector database when the model is the second type.

15. The frame rate conversion method of claim 2, performing pixel-based validation of the reference frame based on a previous frame further comprising:
generating a P-transformed frame based on the previous frame;
comparing the P-transformed frame to the reference frame; and
refining misalignments between the P-transformed frame and the reference frame.

16. The frame rate conversion method of claim 13, performing motion compensation interpolation of the reference frame using the motion vector further comprising:
performing pixel-based interpolation of the reference frame and the previous frame to generate a new frame.

17. An article comprising a medium storing instructions to enable a processor-based system to:
perform pixel-based analysis of a reference frame to generate a motion vector of a model within the reference frame;
perform frame-based analysis of the model, wherein the model is classified as being a first type or a second type;
duplicate the reference frame where the feature is the first type;
perform motion compensation interpolation of the reference frame using the motion vector where the feature is the second type; and
perform pixel-based validation of the reference frame based on a previous frame.

18. The article of claim 17, further storing instructions to enable a processor-based system to:
select a feature from the reference frame;
generate the motion vector for the selected feature; and
prepare a global motion vector database to store the motion vector.

19. The article of claim 17, further storing instructions to enable a processor-based system to:
analyze the global database; and
classify the selected model as being either a global motion model, a no motion model, a complex motion model, or a few objects moving model;
wherein the first type is either a no motion model or a complex motion model and the second type is either a global motion model or a few objects moving model.
